(19) United States
(12) Patent Application Publication
(10) Pub. No.: US 2026/0048672 A1
(43) Pub. Date: Feb. 19, 2026

(54) CHARGING DEVICE AND ELECTRIC VEHICLE

(71) Applicant: MAHLE International GmbH, Stuttgart (DE)

(72) Inventors: Sergio Callejo Signes, Valencia (ES); Alberto Garcia Briz, Valencia (ES)

(21) Appl. No.: 19/298,156

(22) Filed: Aug. 12, 2025

(30) Foreign Application Priority Data
Aug. 13, 2024 (DE) 102024123094.0

(51) Int. Cl. B60L 53/126; B60L 53/20; B60L 53/60; H02J 50/12

(52) U.S. Cl. CPC B60L 53/126; B60L 53/20; B60L 53/60; H02J 50/12; B60L 2210/30

(57) ABSTRACT

A charging device may be configured for installation in an electric vehicle for charging a traction battery of the electric vehicle. The charging device may include a wireless power transfer (WPT) unit, an on-board charging (OBC) unit, a rectifier unit configured to convert an alternating current into a direct current, and/or an output configured to connect to the traction battery of the electric vehicle. The rectifier unit may include three rectifier branches of rectifier switching elements. A first rectifier branch and a second rectifier branch may be connected to the OBC unit and may form a full-bridge rectifier configured to rectify an alternating current supplied via the OBC unit. The second rectifier branch and the third rectifier branch may be connected to the WPT unit and may form a full-bridge rectifier configured to rectify an alternating current supplied via the WPT unit.

### CROSS-REFERENCE TO RELATED APPLICATION

This application claims priority to German Patent Application No. DE102024123094.0 filed on Aug. 13, 2024, the contents of which is hereby incorporated by reference in its entirety.

### TECHNICAL FIELD

The present invention relates to a charging device and an electric vehicle.

### BACKGROUND

US 2018/0290545 A1 discloses a vehicle including a traction battery, an on-board charging (OBC) system, and a wireless power transfer (WPT) system. Both the OBC system and the WPT system are configured to selectively use the same rectifier, so that the rectifier rectifies the output of the OBC system and rectifies the output of the WPT system to provide power to the traction battery.

WPT, which uses magnetic resonance, is the technology that could free people from annoying cables. WPT is actually based on the same theory that has been developed for at least 30 years under the term inductive energy transfer. WPT technology has developed rapidly in recent years. At a power output of several kilowatts, the distance increases from a few millimeters to several hundred millimeters with an efficiency of over 90% between the mains and the load. These advances make WPT very attractive for charging applications in electric vehicles (EVs), both in stationary and dynamic charging scenarios. The introduction of WPT in EVs can easily mitigate the obstacles of charging time, range, and cost, and battery technology is no longer as relevant in the EV market.

When AC power is converted to low-voltage DC power or AC power is converted from one frequency to another, the AC power is usually rectified and smoothed to obtain a fixed voltage at a fixed frequency. Once this is achieved, the electricity is forwarded to an inverter to obtain the final output with variable voltage and variable frequency.

EP 3694079 A1 discloses a WPT system for an electric vehicle (EV), wherein the WPT system comprises a ground assembly (GA) including a transmitter coil and a vehicle assembly (vehicle assembly, VA) including a receiver coil magnetically coupled to the GA transmitter coil to transfer inductive energy from the GA to the VA to charge a traction battery of the EV. In addition, an OBC system is connected to the traction battery in parallel with the WPT system.

In general, OBC systems and WPT systems do not share large parts of an electronic stage and are installed separately in EVs (depending on the configuration). Architectural optimization can only be achieved by integrating both systems into a common housing and sharing certain components (e.g., connectors, output filters, etc.). Separate controls require arbitration/synchronization by a higher-level control in the vehicle architecture. In addition, simultaneous charging may not be desirable.

There is currently no integrated system available on the market. The costs and system complexity generally increase when both systems (OBC and WPT) are planned for a vehicle. In some cases, complex and expensive switches were proposed to switch between systems depending on the application. Coordination of the charging process (OBC vs. WPT) may be necessary at the vehicle level, which requires additional effort.

### SUMMARY

The objective of the present invention is to provide a charging system that integrates an OBC unit and a WPT unit with reasonable complexity and cost. Furthermore, it is an objective of the present invention to provide a corresponding electric vehicle.

In a first aspect of the present invention, a charging device is presented which is configured for installation in an electric vehicle for charging a traction battery of the electric vehicle, wherein the charging device comprises:
a wireless power transfer (WPT) unit with a WPT receiver coil configured to inductively receive electrical power from a WPT transmitter coil;
a vehicle-mounted charging unit (OBC) with an OBC input configured to connect a power supply connector for supplying electrical power from a power supply system;
a rectifier unit connected to the WPT unit and the OBC unit and configured to convert alternating current supplied from the WPT unit or the OBC unit into direct current; and
an output configured to connect to the traction battery of the electric vehicle to supply DC power to the traction battery,
wherein the rectifier unit comprises three rectifier branches of rectifier switching elements,
wherein a first rectifier branch and a second rectifier branch are connected to the OBC unit and form a full-bridge rectifier configured to rectify alternating current supplied by the OBC unit and
wherein the second rectifier branch and a third rectifier branch are connected to the WPT unit and form a full-bridge rectifier configured to rectify alternating current supplied by the WPT unit.

In another aspect of the present invention, an electric vehicle is presented that comprises a traction battery and a charging device disclosed herein for charging the traction battery.

Preferred embodiments of the invention are defined in the dependent claims. It is understood that the claimed electric vehicle has similar and/or identical preferred embodiments as the claimed charging device, in particular as defined in the dependent claims and as disclosed herein.

The present invention is based on the idea of sharing the rectifier unit between the OBC unit and the WPT unit. For this purpose, an additional (second) rectifier branch is added, which is shared and used either together with a first rectifier branch to rectify the alternating current supplied by the OBC unit or together with a third rectifier branch to rectify the alternating current supplied by the WPT unit. This is a cost-effective solution that requires only a minimum of additional hardware and space. Additional switches, such as those used in known charging devices, can be avoided, but by using the second rectifier branch, it is possible to properly isolate the OBC unit and the WPT unit.

Active rectifier components (IGBTs, SiC, GaN, etc.) of a conventional WPT system can be added according to a current passive (or active) rectifier circuit of a conventional OBC system to enable both charging modes. A basic electronic architecture can be used to combine both power amplifiers and avoid the need for subsystem power switches. The additional second rectifier branch provides this combination. In one embodiment, the active rectifier of a conventional WPT system can be used as the second and third rectifier branches. An additional rectifier branch is added as the first rectifier branch. In other words, a rectifier branch of the active rectifier of the conventional WPT system is shared with the OBC unit.

In one embodiment, a first output terminal of the OBC unit and a first output terminal of the WPT unit are connected to an input terminal of the second rectifier branch. Furthermore, in one embodiment, a second output terminal of the OBC unit is connected to an input terminal of the first rectifier branch, and a second output terminal of the WPT unit is connected to an input terminal of the third rectifier branch. Furthermore, in a further embodiment, the first output terminals of the three rectifier branches are connected to each other, and the second output terminals of the three rectifier branches are connected to each other. This enables the rectifier branches to be connected in a meaningful way, allowing simple and efficient control and circuit of the rectifier switching elements.

In a preferred embodiment, each rectifier branch comprises two rectifier switching elements, in particular semiconductor switching elements. These can be active rectifier components (IGBTs, SiC, GaN, etc.).

In one embodiment, the charging device further comprises a control unit configured to control the rectifier switching elements. The control unit can be implemented in hardware and/or software, e.g., as a controller or processor that executes a control algorithm.

The control unit can be configured to detect whether alternating current is being supplied by the OBC unit or the WPT unit, and that it opens the rectifier switching elements of the first rectifier branch when alternating current is supplied from the WPT unit, and that it opens the rectifier switching elements of the third rectifier branch when alternating current is supplied from the OBC unit. This prevents simultaneous charging of the traction battery by the OBC unit and the WPT unit.

The control unit may further be configured to open the rectifier switching elements of the second rectifier branch when neither the WPT unit nor the OBC unit is supplying alternating current. This isolates the system from external influences (e.g., power surges in the grid or interference in multi-GA systems) and also ensures a safe EV environment (vehicle AC plug with no voltage at the power pins). Furthermore, potential internal currents are avoided (no closed circuit when not charging), thus preventing high-voltage discharge of the battery.

In another embodiment, the OBC unit and/or the WPT unit are configured for bidirectional power transfer, and the control unit is configured to control the rectifier switching elements according to the direction of power transfer. This allows current to flow from the OBC unit or the WPT unit to the traction battery or vice versa, i.e., current can flow from the grid to the vehicle and from the vehicle to the grid.

In one embodiment, the rectifier unit comprises one or more additional rectifier branches, wherein the second rectifier branch and an additional rectifier branch are connected to an additional AC power supply unit and form a full-bridge rectifier configured to rectify the AC power supplied by the additional AC power supply unit. This allows the use of one or more additional power supplies, which share the second rectifier unit, thereby saving many additional components.

The charging device may further comprise a housing in which the OBC unit and the WPT unit are jointly accommodated. This saves space and time for installing two separate units.

### BRIEF DESCRIPTION OF THE DRAWINGS

The preceding sections serve as a general introduction and are not intended to limit the scope of the following claims. A more comprehensive assessment of the disclosure and many of its associated advantages will be readily apparent from a review of the following detailed description, which should be read in conjunction with the accompanying drawings, wherein:

FIG. 1 shows a schematic diagram of the general structure of a WPT system for an EV;

FIG. 2 shows a schematic diagram of a commonly known OBC system for an EV;

FIG. 3 shows a schematic diagram of a charging device according to the present invention;

FIG. 4 shows a circuit diagram of an embodiment of a rectifier unit according to the present invention;

FIG. 5 shows the rectifier unit as shown in FIG. 4, with the full-bridge rectifier used for OBC charging indicated;

FIG. 6 shows the rectifier unit as shown in FIG. 4, with the full-bridge rectifier used for WPT charging indicated; and

FIG. 7 is a circuit diagram of an embodiment of a further rectifier unit according to the present invention.

### DETAILED DESCRIPTION

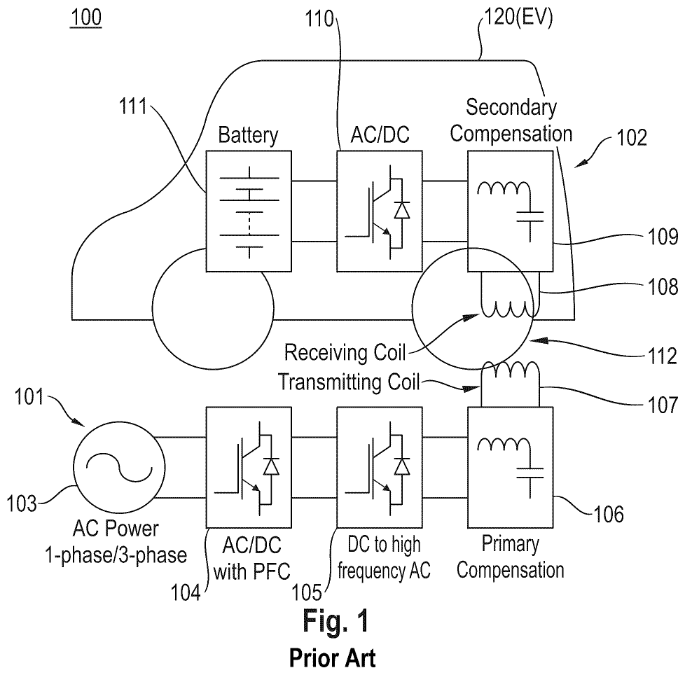

FIG. 1 shows a schematic diagram of a generally known WPT system 100 for an EV 120, as disclosed in EP 3694079 A1, for example. In this WPT system 100, the basic functional blocks for inductive charging are shared by a ground assembly (GA) 101 and a vehicle assembly (VA) 102, each of which constitutes a separate WPT device of the WPT system 100. The WPT system 100 comprises an inductive charging coil assembly 112, which comprises a transmitter coil (also referred to as a GA coil) 107 on the GA side and a receiver coil (also referred to as a VA coil) 108 on the vehicle side.

The GA 101 of the WPT System 100 comprises an AC/DC converter 104 with power factor correction (PFC), which converts the single-phase or three-phase current supplied by an (external) AC power source 103 into regulated direct current. The GA 101 also comprises a direct current high-frequency (HF) alternating current converter 105, which generates a square wave voltage with a nearly constant frequency and constant duty cycle. A primary compensation circuit 106, which is a passive circuit network, compensates for the inductance of the transmitter coil in order to reduce the reactive power supplied by the DC-to-AC converter 105. The transmitter coil 107 transmits energy via a magnetic field and provides additional insulation between the AC input and the vehicle's high-voltage (HV) battery 111 (also known as the traction battery).

The VA 102 comprises a receiver coil 108, which picks up the current through the magnetic field and reinforces the insulation between the AC input and the vehicle HV battery 111. A secondary compensation circuit 109, which is a passive circuit network, compensates for the inductance of the receiver coil to maximize the transferred power at electrical resonance. The VA 102 comprises an (active or passive) AC/DC rectifier 110 that converts high-frequency alternating current into direct current to charge the vehicle's HV battery. A DC/DC battery charger (including or excluding battery charging algorithms/charging strategy) may be provided. The VA 102 can include the HV battery 111 or be connected to the HV battery 111.

The architecture of the VA can vary depending on many criteria, including network compensation or the charging/discharging strategy. The high-voltage battery 111 can potentially be charged by both assemblies, GA 101 and VA 102, of the WPT system 100, allowing an optimal WPT architecture to be determined.

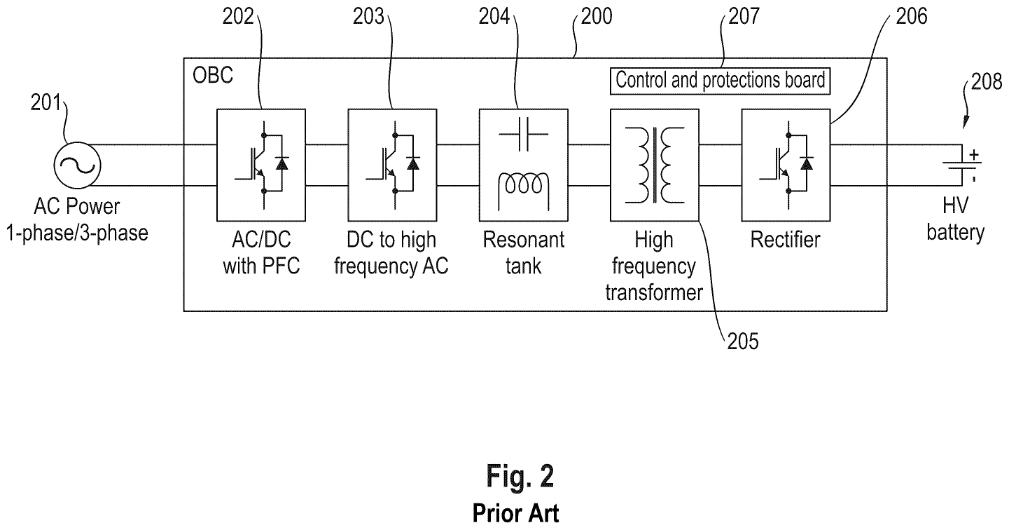

FIG. 2 shows a schematic diagram of a commonly known OBC system 200 for an EV 120. It comprises an AC/DC converter 202 with PFC, which converts the single-phase or three-phase current supplied by an (external) AC power source 201 into regulated direct current. The OBC system 200 also comprises a direct current high-frequency (HF) alternating current converter 203, which generates a square-wave voltage with variable or constant frequency depending on the operating point of the battery and the power required. A resonance tank 204 ensures power transfer at resonance to maximize the efficiency of the power converter. A high-frequency transformer 205 provides isolation between the AC power supply (components 203, 204) and the vehicle HV battery 208, which corresponds to the vehicle AV battery 111 shown in FIG. 1. A rectifier 206 converts high-frequency alternating current into direct current to charge the vehicle HV battery 208. This may be an active or passive rectifier, e.g., with diodes, IGBTs, MOSFETs, etc. One or more control and protection boards 207 may be provided to control and protect the components of the OBC system 200.

Assuming that both charging systems, i.e., the WPT system 100 and the OBC system 200, are used and implemented separately, sufficient space must be provided in the vehicle for the installation of both charging systems, including one or more electrical cable harnesses and connectors for high-and low-voltage power supply, communication, cooling hoses, and connectors, etc. In addition, a separate control system is provided, which requires arbitration and synchronization from a higher level. This increases costs, complexity, space requirements, and other expenses.

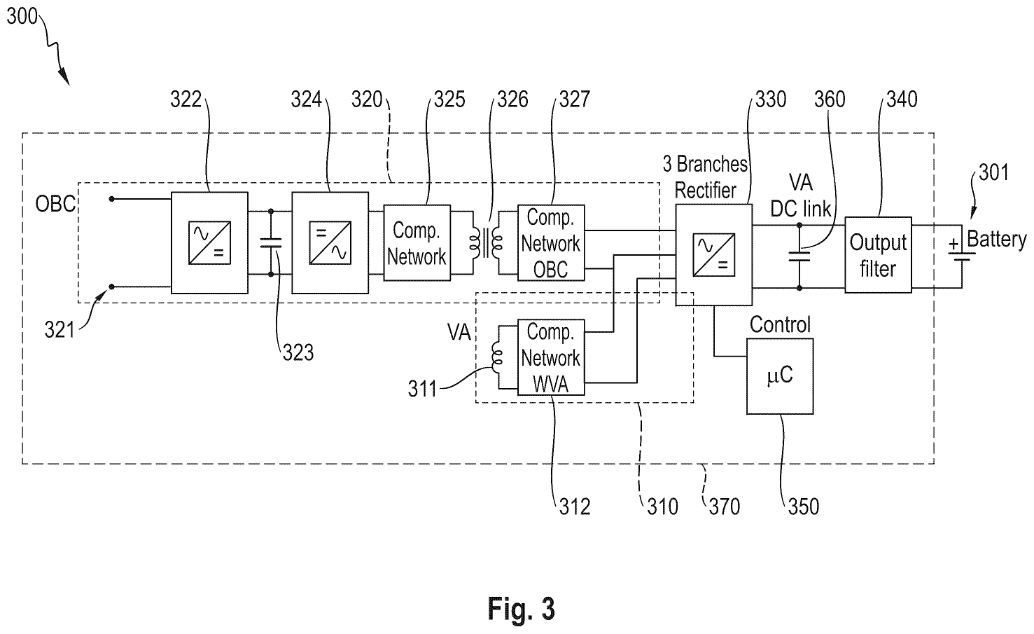

FIG. 3 shows a schematic diagram of a charging device 300 according to the present invention, which is configured for installation in an EV for charging a traction battery 301 of the EV. The charging device 300 comprises a WPT unit 310 with a WPT receiver coil 311 configured to inductively receive electrical power from a WPT transmitter coil (107 in FIG. 1; not shown in FIG. 3 and not part of the charging device 300). The power device 300 further comprises an OBC unit 320 with an OBC input 321 configured to connect a power supply connector for supplying electrical energy from a power supply system, such as an AC power source (201 in FIG. 2; not shown in FIG. 3 and not part of the charging device 300). A rectifier unit 330 is connected to the WPT unit 310 and the OBC unit 320 and configured to convert the alternating current supplied by the WPT unit 310 or the OBC unit 320 into direct current, i.e., the rectifier unit 330 is shared by the WPT unit 310 and the OBC unit 320. An output 340, e.g., an output filter, is provided and configured to connect the traction battery 301 of the electric vehicle to supply DC power to the traction battery 301. Preferably, a control unit 350 is provided to control the rectifier unit 330, and a capacitor 360 (which functions as a DC connection) is provided between the rectifier unit 330 and the output 340. Details and embodiments of the rectifier unit 330 are discussed below.

In preferred embodiments, the WPT unit 310 comprises a compensation network 312, in particular for compensating reactive power. The compensation network can be implemented as a primary compensation circuit (106 in FIG. 1), e.g., as a passive circuit network that compensates for the inductance of the transmitter coil in order to reduce the reactive power supplied by a DC-to-AC converter (105 in FIG. 1).

In preferred embodiments, the OBC unit 320 comprises an AC/DC converter 322 (preferably) with PFC, which converts the single-phase or three-phase power supplied by an (external) AC source (201 in FIG. 2; not shown in FIG. 3) into regulated DC power, which can be implemented as the AC/DC converter 202 shown in FIG. 2. The OBC unit 320 also comprises a capacitor 323 (which acts as a DC intermediate circuit) and a DC-to-AC converter 324, which generates a square wave voltage with variable or constant frequency depending on the operating point of the battery and the power required and can be implemented like the DC-to-high-frequency (HF) converter 203 shown in FIG. 2. An RF transformer 326 with a compensation network 325, 327 at its input and output, respectively, provides isolation between the RF AC converter 324 and the battery 301 and can be implemented as the RF transformer 205 shown in FIG. 2.

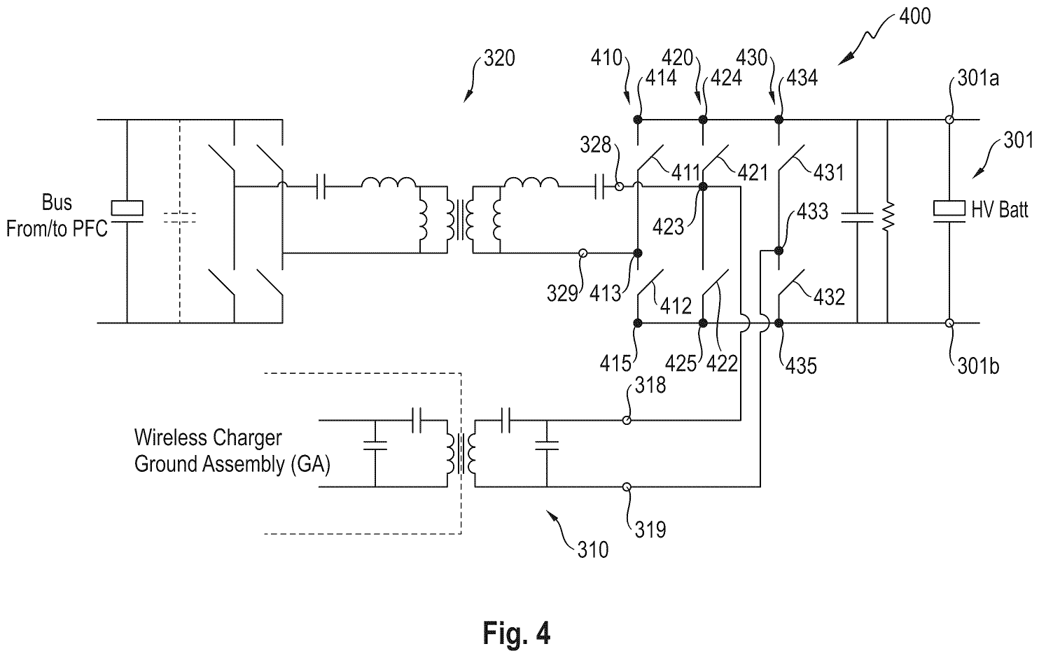

FIG. 4 shows a circuit diagram of an embodiment of a rectifier unit 400 that can be used as the rectifier unit 330 shown in FIG. 3. The rectifier unit 400 is coupled on the input side to the WPT unit 310 and the OBC unit 320, which can be implemented in the same way as shown in FIG. 3, but also in other ways. At its output, the rectifier unit 400 is connected to the HV battery 301.

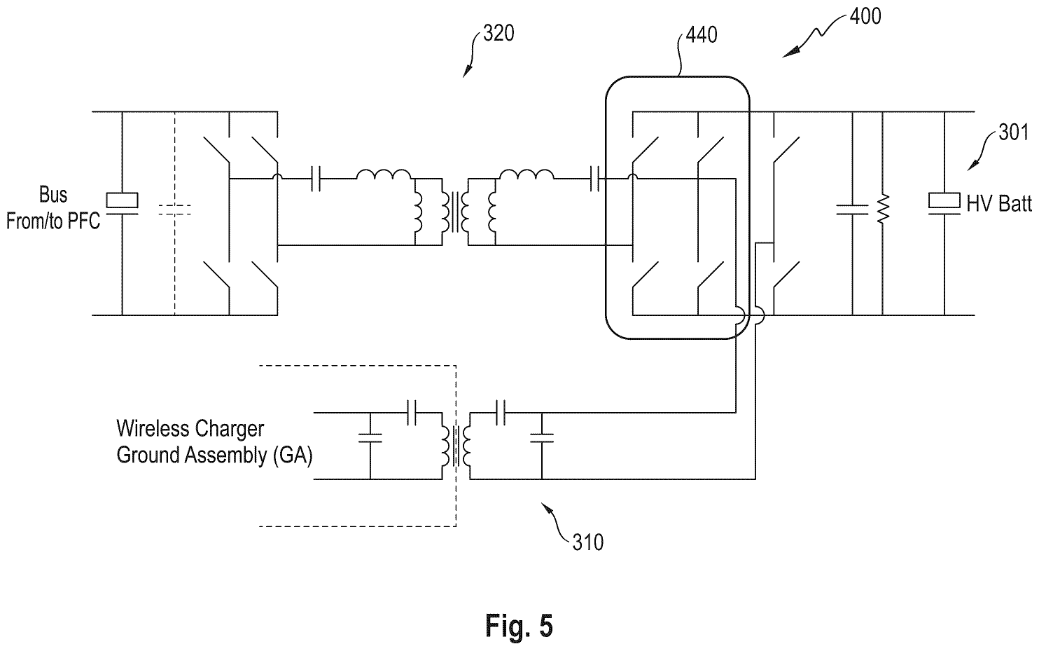

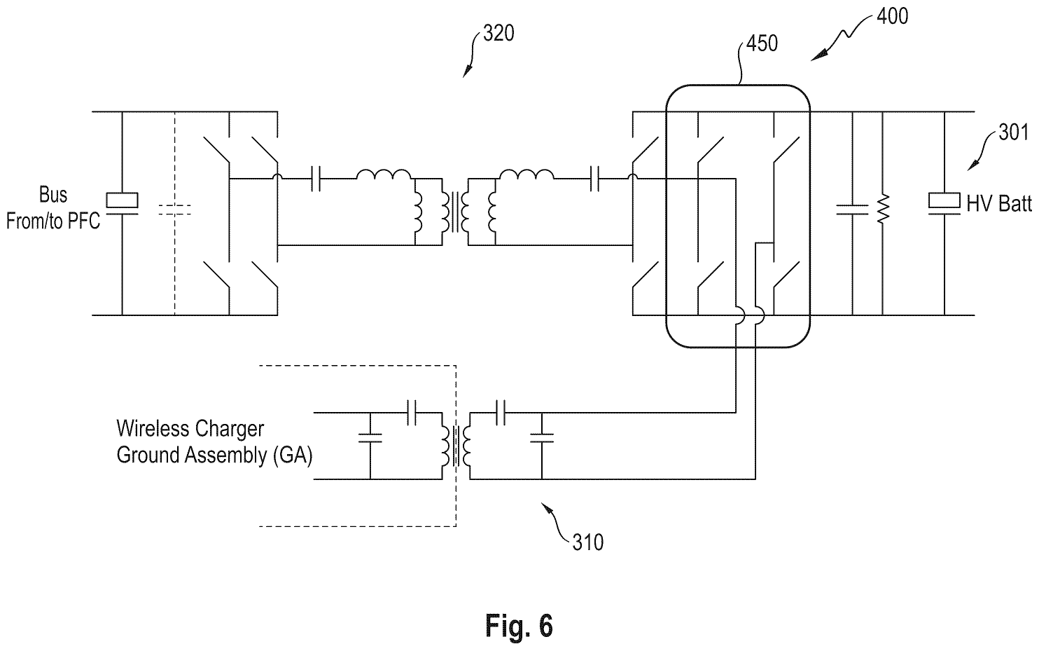

The rectifier unit 400 comprises three rectifier branches 410, 420, 430, each of which comprises rectifier switching elements, in this embodiment two rectifier switching elements 411, 412, 421, 422, 431, 432. The first rectifier branch 410 and the second rectifier branch 420 are connected to the OBC unit 320 and form a full-bridge rectifier 440 configured to rectify alternating current supplied by the OBC unit 320. This is illustrated in FIG. 5, in which the rectifier unit 400 is shown as in FIG. 4, with the full-bridge rectifier 440 indicated. The second rectifier branch 420 and the third rectifier branch 430 are connected to the WPT unit 310 and form a full-bridge rectifier 450 configured to rectify alternating current supplied by the WPT unit 310. This is illustrated in FIG. 6, in which the rectifier unit 400 is shown as in FIG. 4, with the full-bridge rectifier 450 indicated. The second rectifier branch is therefore shared by the WPT unit 310 and the OBC unit 320 and is used either together with the first rectifier branch 410 or the third rectifier branch 430, but generally not simultaneously with both rectifier branches.

In one embodiment, a first output terminal 328 of the OBC unit 320 and a first output terminal 318 of the WPT unit 310 are connected to an input terminal 423 of the second rectifier branch 420. A second output terminal 329 of the OBC unit 320 is connected to an input terminal 413 of the first rectifier branch 310, and a second output terminal 319 of the WPT unit 310 is connected to an input terminal 433 of the third rectifier branch 330.

Furthermore, in one embodiment, the first output terminals 414, 424, 434 of the three rectifier branches 410, 420, 430 are connected to each other and connected to the first input terminal 301a of the battery 301. The second output terminals 415, 425, 435 of the three rectifier branches 410, 420, 430 are connected to each other and to the second input terminal 301b of the battery 301.

The control unit (350 in FIG. 3) controls the rectifier switching elements 411, 412, 421, 422, 431, 432 to perform the desired rectification of the alternating current supplied by the WPT unit 310 or the OBC unit 320. The control unit preferably detects whether the alternating current is supplied by the OBC unit 320 or by the WPT unit 310. If alternating current is supplied by the WPT unit 310, it opens the rectifier switching elements 411, 412 of the first rectifier branch 410. If alternating current is supplied by the OBC unit 320, it opens the rectifier switching elements 431, 432 of the third rectifier branch 430. [Furthermore], if no alternating current is supplied by the WPT unit 310 and no alternating current is supplied by the OBC unit 320, the control unit opens the rectifier switching elements 421, 422 of the second rectifier branch 420.

In general, unused switch branches, i.e., switch branches connected to power sources that are not present or do not supply power, are controlled so that they remain open circuits to prevent unwanted currents in the vehicle. In the specific case of a charging device that has wired and wireless charging units, such as in the embodiment shown in FIGS. 3 through 6, several switching strategies can be used. When charging in wired mode, it is preferable to keep all rectifier switching elements of the non-shared branch of the rectifier unit open so that the current cannot flow through the WPT unit. The same applies to charging in wireless mode. To isolate the OBC unit, all rectifier switching elements that are not shared with the wireless mode should remain open while wireless charging is in progress.

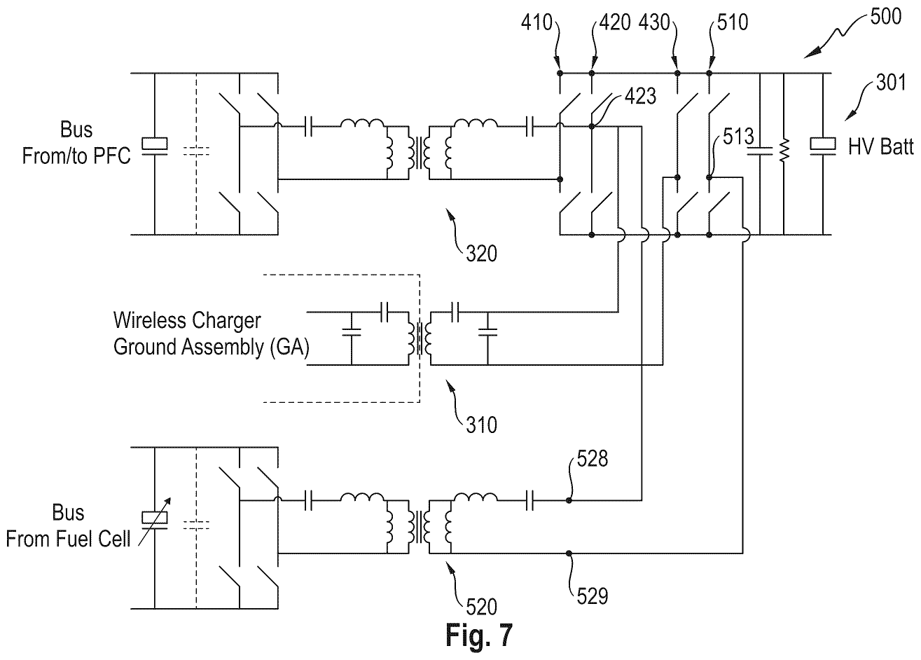

FIG. 7 shows a circuit diagram of another embodiment of a rectifier unit 500 that can be used as rectifier unit 330 shown in FIG. 3. In this embodiment, the rectifier unit 500 comprises, in addition to the three rectifier branches 410, 420, 430, a further rectifier branch 440 (there may also be two or more further rectifier branches). The second rectifier branch 420 and the further rectifier branch 510 are connected to a further AC power supply unit 520 and form a full-bridge rectifier which is configured to rectify the alternating current supplied by the further AC power supply unit 520. A first output terminal 528 of the further AC power supply unit 520 is connected to the input terminal 423 of the second rectifier branch 420. A second output terminal 529 of the further AC power supply unit 520 is connected to an input terminal 513 of the further rectifier branch 510.

The additional AC power supply unit 520 may include, for example, a fuel cell or another electrical energy source or a generator. In general, according to embodiments of the present invention, multiple charging sources (e.g., including fuel cell vehicles or low-voltage DC-DC stages) can be provided that share a rectification and output filter stage.

In another embodiment, bidirectionality can be added to the subsystems capable of this, and a single common control can be provided, e.g., by the control unit 350. The OBC unit 320 and/or the WPT unit 310 may therefore be configured for bidirectional power transfer, and the control unit 350 may be configured to control the rectifier switching elements according to the direction of power transfer.

In a further embodiment, the charging device further comprises a housing 370 (as shown in FIG. 3), which typically accommodates the OBC unit 320 and the WPT unit 310, preferably all components of the charging device 300.

As explained above, the charging device of the present invention can be advantageously used in an electric vehicle comprising a traction battery and the charging device for charging the traction battery.

While the invention has been illustrated and described in detail in the drawings and the preceding description, these illustrations and descriptions are to be regarded as illustrative or exemplary and not limiting; the invention is not limited to the disclosed embodiments. Other variations of the disclosed embodiments can be understood and carried out by those skilled in the art in the process of putting the claimed invention into practice, based on the drawings, the disclosure, and the accompanying claims.

In the claims, the word “comprising” does not exclude other elements or steps, and the indefinite article “a” or “an” does not exclude a plural. A single element or other unit may fulfill the functions of several elements listed in the claims. The mere fact that certain dimensions are specified in different dependent claims does not indicate that a combination of these dimensions cannot be used advantageously.

Any references in the claims are not to be interpreted as limitations of the scope of protection.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase “at least one of” followed by successive elements separate by the word “and” (e.g., “at least one of A and B”) is to be interpreted the same as “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g. ” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

All matter contained in the above description or shown in the accompanying drawings shall be interpreted as illustrative only and not limiting. Changes in detail or structure may be made without departing from the present disclosure.

1. A charging device configured for installation in an electric vehicle for charging a traction battery of the electric vehicle, the charging device comprising:
a wireless power transfer (WPT) unit including a WPT receiver coil configured to inductively receive electrical power from a WPT transmitter coil;
an on-board charging (OBC) unit including an OBC input configured to connect a power supply connector for supplying electrical power from a power supply system;
a rectifier unit connected to the WPT unit and the OBC unit, the rectifier unit configured to convert an alternating current supplied via the WPT unit and/or the OBC unit into a direct current; and
an output configured to connect to the traction battery of the electric vehicle to provide the direct current to the traction battery;
wherein the rectifier unit includes three rectifier branches of rectifier switching elements;
wherein a first rectifier branch and a second rectifier branch of the three rectifier branches are connected to the OBC unit and form a full-bridge rectifier configured to rectify the alternating current supplied via the OBC unit; and
wherein the second rectifier branch and a third rectifier branch of the three rectifier branches are connected to the WPT unit and form a full-bridge rectifier configured to rectify the alternating current supplied via the WPT unit.

2. The charging device according to claim 1, wherein an output terminal of the OBC unit and an output terminal of the WPT unit are connected to an input terminal of the second rectifier branch.

3. The charging device according to claim 2, wherein:
a second output terminal of the OBC unit is connected to an input terminal of the first rectifier branch; and
a second output terminal of the WPT unit is connected to an input terminal of the third rectifier branch.

4. The charging device according to claim 1, wherein:
the three rectifier branches each include a first output terminal and a second output terminal;
the first output terminals of the three rectifier branches are connected to each other; and
the second output terminals of the three rectifier branches are connected to each other.

5. The charging device according to claim 1, wherein each rectifier branch of the three rectifier branches includes two rectifier switching elements.

6. The charging device according to claim 1, further comprising a control unit configured to control the rectifier switching elements.

7. The charging device according to claim 6, wherein the control unit is configured to:
detect whether AC power is supplied from the OBC unit and/or the WPT unit;
open the rectifier switching elements of the first rectifier branch when the alternating current is supplied from the WPT unit; and
open the rectifier switching elements of the third rectifier branch when the alternating current is supplied from the OBC unit.

8. The charging device according to claim 7, wherein the control unit is configured to open the rectifier switching elements of the second rectifier branch when neither the WPT unit nor the OBC unit is supplying the alternating current.

9. The charging device according to claim 6, wherein:
the OBC unit and/or the WPT unit are configured for bidirectional power transfer; and
the control unit is configured to control the rectifier switching elements of at least one of the three rectifier branches according to a direction of power transfer.

10. The charging device according to claim 1, wherein:
the rectifier unit further includes at least one further rectifier branch; and
the second rectifier branch and the at least one further rectifier branch are connected to a further AC power supply unit and form a full-bridge rectifier configured to rectify an alternating current supplied via the further AC power supply unit.

11. The charging device according to claim 1, further comprising a housing in which the OBC unit and the WPT unit are jointly accommodated.

12. An electric vehicle, comprising a traction battery and a charging device according to claim 1 for charging the traction battery.

13. The charging device according to claim 1, wherein the OBC unit is a vehicle-mounted OBC unit.

14. The charging device according to claim 1, wherein at least some of the rectifier switching elements are semiconductor switching elements.

15. The charging device according to claim 1, wherein:
an output terminal of the OBC unit is connected to an input terminal of the first rectifier branch; and
an output terminal of the WPT unit is connected to an input terminal of the third rectifier branch.

16. The charging device according to claim 1, wherein:
the OBC unit includes i) a first output terminal connected to an input terminal of the second rectifier and ii) a second output terminal connected to an input terminal of the first rectifier branch; and/or
the WPT unit includes i) a first output terminal connected to the input terminal of the second rectifier and ii) a second output terminal connected to an input terminal of the third rectifier branch.

17. The charging device according to claim 1, further comprising a capacitor disposed between the rectifier unit and the output.

18. The charging device according to claim 1, further comprising a capacitor disposed between the rectifier unit and the output.

19. The charging device according to claim 1, wherein:
a first output terminal of the first rectifier branch, a first output terminal of the second rectifier branch, and a first output terminal of the third rectifier branch are connected to each other and are connectable to a first input terminal of the traction battery; and
a second output terminal of the first rectifier branch, a second output terminal of the second rectifier branch, and a second output terminal of the third rectifier branch are connected to each other and are connectable to a second input terminal of the traction battery.

20. The charging device according to claim 1, further comprising a control unit configured to control the rectifier switching elements, wherein the control unit is configured to open the rectifier switching elements of one of the three rectifier branches according to whether i) AC power is received from the OBC unit, ii) AC power is received from the WPT unit, and iii) no AC power is received from the OBC unit nor from the WPT unit.
